(19) United States
(12) Patent Application Publication
(10) Pub. No.: US 2011/0159473 A1
(43) Pub. Date: Jun. 30, 2011

(54) ARRAY OF ELECTRICAL CONNECTORS HAVING OFFSET ELECTRICAL CONNECTORS

(76) Inventors: Alan D. Crighton, Apex, NC (US); Steven E. Minich, York, PA (US); Dean E. Geibel, Dover, PA (US)

(21) Appl. No.: 12/982,314

(22) Filed: Dec. 30, 2010

Related U.S. Application Data
(63) Continuation-in-part of application No. 12/949,241, filed on Nov. 18, 2010.
(60) Provisional application No. 61/291,569, filed on Dec. 31, 2009.
(60) Provisional application No. 61/365,853, filed on Jul. 20, 2010.

(51) Int. Cl. G09B 25/00; H01R 12/70

(52) U.S. Cl. 434/379; 439/65

(57) ABSTRACT

An array of electrical connectors is provided having a first plurality of electrical connectors configured to be mounted on a substrate, and a second plurality of electrical connectors configured to be mounted on the substrate at a location adjacent the first plurality of electrical connectors, such that the first plurality of electrical connectors is offset with respect to the second plurality of electrical connectors along an insertion direction.

### CROSS-REFERENCE TO RELATED APPLICATIONS

This patent application is a continuation-in-part of U.S. patent application Ser. No. 12/949,241, filed Nov. 18, 2010, which claims the benefit of U.S. Patent Application Ser. No. 61/291,569, filed Dec. 31, 2009, the disclosure of each of which is hereby incorporate by reference in its entirety. This patent application further claims the benefit of U.S. Patent Application Ser. No. 61/365,853, filed Jul. 20, 2010; the disclosure of which is hereby incorporated by reference in its entirety.

### BACKGROUND

First mate, last break contacts can be used to lower electrical connector insertion force and to ensure that ground contacts mate before signal contacts. However, because an insertion force is associated with the mating of a given pair of complementary electrical contacts, and because complementary arrays of electrical contacts include a large number of electrical contacts that are mated, such configurations can be associated with high insertion forces even with first mate, first break contact configurations. Insertion force can be measured in accordance with Electronic Industries Alliance (EIA) Standard 364-13, which is hereby incorporated by reference in its entirety. The high insertion forces can place high stresses on the electrical contacts and is generally undesirable.

### SUMMARY

In accordance with one embodiment, electrical connectors comprising first mate, first break electrical contacts (usually longer ground mating ends) are offset from one another or with respect to a front edge of a substrate. In another embodiment, electrical connectors not having first mate, first break electrical contacts (usually longer ground mating ends) are offset from one another or with respect to a front edge of a substrate. Recessing some electrical connectors from a front edge of a substrate of a first or second electrical component, possibly in addition to a first mate, first break contact configuration, further lowers insertion force.

Another embodiment includes an array of electrical connectors. The array of electrical connectors may include a first plurality of electrical connectors and a second plurality of electrical connectors. Each electrical connector of the first plurality of electrical connectors includes a connector housing and a plurality of electrical contacts supported by the connector housing. Each electrical contact defines a mounting end configured to electrically connect to a substrate and a mating end configured to electrically connect to a respective electrical contact of a complementary electrical connector of a second array of electrical connectors along an insertion direction. Each electrical connector of the second plurality of electrical connectors includes a connector housing and a plurality of electrical contacts supported by the connector housing. Each electrical contact of the second plurality of electrical contacts defines a mounting end configured to electrically connect to the substrate and a mating end configured to electrically connect to a respective electrical contact of a complementary electrical connector of the second array of electrical connectors along the insertion direction. The mating ends of the electrical contacts of the first plurality of electrical connectors are offset with respect to the mating ends of the electrical contacts of the second plurality of electrical connectors along the insertion direction. At least one of the electrical connectors of the first plurality of electrical connectors has a different number of electrical contacts with respect to at least one of the electrical connectors of the second plurality of electrical connectors.

Another embodiment includes a method to make a printed circuit board that has reduced insertion force. The method may include the steps of mounting second electrical connectors along an edge of a substrate and mounting third electrical connectors along the edge of the substrate, adjacent to the second electrical connectors, and offset from the second electrical connectors along an insertion direction, wherein the first plurality of electrical connectors and the second plurality of electrical connectors each comprise identical electrical connectors.

### DESCRIPTION OF THE DRAWINGS

The foregoing summary, as well as the following detailed description of the preferred embodiments of the application, will be better understood when read in conjunction with the appended drawings. For the purposes of illustrating an array of electrical connectors having offset electrical connectors as described herein, there are shown in the drawings preferred embodiments. It should be understood, however, that the instant application is not limited to the precise arrangements and/or instrumentalities illustrated in the drawings, in which:

FIG. 1 is a perspective view of an electrical connector assembly including a first array of electrical connectors and a second array of electrical connectors each mounted to a respective first and second substrates, showing the electrical connectors of the first array of electrical connectors configured to be mated to the electrical connectors of the second array of electrical connectors;

FIG. 2A is an enlarged perspective view of a portion of the electrical connector assembly illustrated in FIG. 1, showing a first electrical connector of the first array of electrical connectors mounted to the first substrate and a second electrical connector of the second array of electrical connectors mounted to the second substrate;

FIG. 2B is a perspective view of the first and second electrical connectors illustrated in FIG. 2A;

FIG. 3A is a side elevation view of a first leadframe assembly of the second electrical connector illustrated in FIG. 2A;

FIG. 3B is a side elevation view of a second leadframe assembly of the second electrical connector illustrated in FIG. 2A;

FIG. 4 is a perspective view of the first array of electrical connectors schematically illustrated and shown mounted to the first substrate as illustrated in FIG. 1;

FIG. 5A is a perspective view of the second substrate illustrated in FIG. 1;

FIG. 5B is a perspective view of the second array of electrical connectors schematically illustrated and shown mounted to the second substrate as illustrated in FIG. 1;

FIG. 5C is a top plan view of the second array of electrical connectors illustrated in FIG. 5B, showing a first plurality of electrical connectors of the second array offset with respect to a second plurality of electrical connectors of the second array;

FIG. 6A is a perspective view of the second substrate similar to FIG. 5A, but constructed in accordance with an alternative embodiment;

FIG. 6B is a top plan view of the second array of electrical connectors mounted onto the second substrate illustrated in FIG. 6A;

FIG. 7A is a perspective view of the second substrate similar to FIG. 5A, but constructed in accordance with another alternative embodiment; and

FIG. 7B is a top plan view of the second array of electrical connectors mounted onto the second substrate illustrated in FIG. 7A.

### DETAILED DESCRIPTION

In accordance with one embodiment, insertion force created when two or more right-angle daughtercard connectors mate with corresponding vertical backplane or midplane connectors can be reduced by setting at least one of the two or more right-angle daughtercard electrical connectors on the daughtercard back from an edge of the daughtercard to stagger the mating of at least two of the two or more right-angle daughtercard connectors.

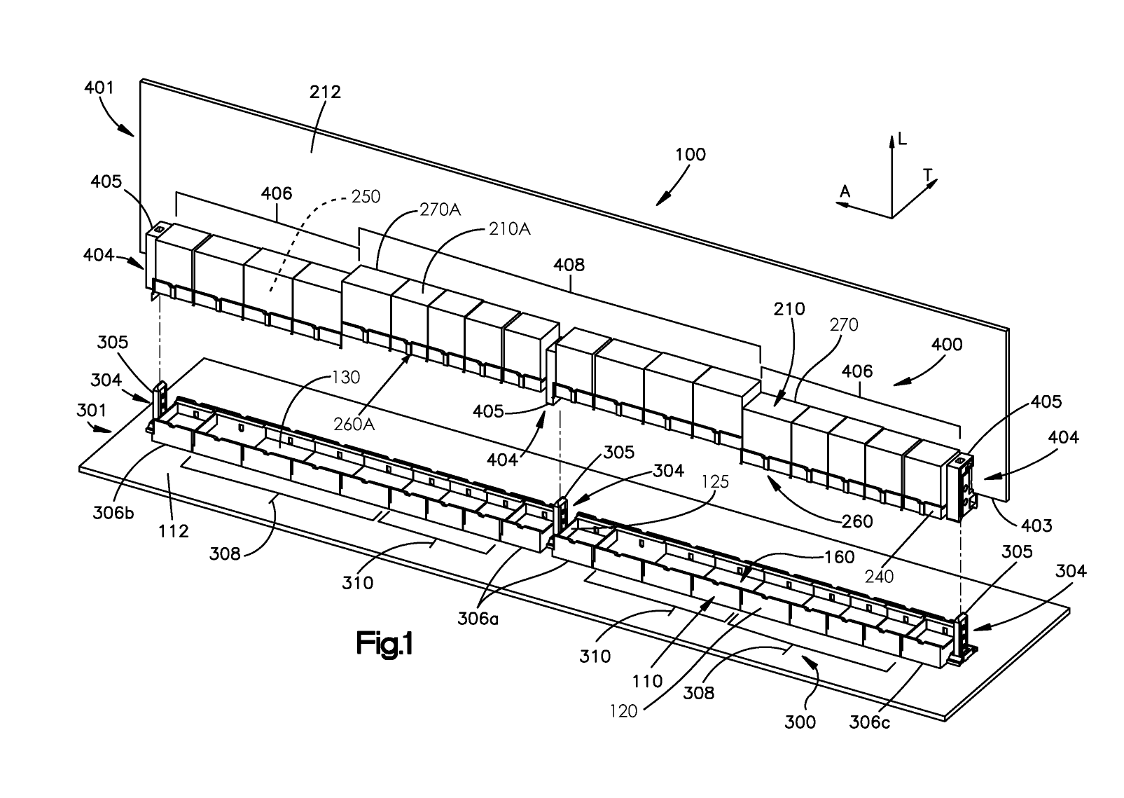

As shown in FIG. 1, an electrical connector assembly 100 may include a first electrical component 301. The first electrical component 301 may include a first array 300 of first electrical connectors 110. The first electrical connectors 110 may each be the same type, i.e, vertical or right angle, with the same number of first electrical contacts 130 or a different number of first electrical contacts 130. A second electrical component 401 may include a second array 400 of second and third electrical connectors 210, 210A. The second and third electrical connectors 210, 210A may each be the same type (i.e, right angle or vertical) with the same number of second electrical contacts 250 or a different number of second electrical contacts 250. The first array 300 of first electrical connectors 110 may be configured to mate with a second array 400 of second electrical connectors 210 and third electrical connectors 210A along an insertion direction L. The second array 400 of second and third electrical connectors 210, 210A may include a third plurality 406 of second electrical connectors 210 and a fourth plurality 408 of third electrical connectors 210A, wherein the fourth plurality 408 of third electrical connectors 210A is recessed with respect to the third plurality 406 of second electrical connectors 210. When the first and second electrical components 301, 401 are mated, the first plurality 308 of first electrical connectors 110 mate with the third plurality 406 of second electrical connectors 210 before the second plurality 310 of first electrical connectors 110 mate with the fourth plurality 408 of third electrical connectors 210A.

With continuing reference to FIG. 1, each of the first electrical connectors 110 is configured to be mounted to a common first substrate 112, and each of the second and third electrical connectors 210, 210A are configured to be mounted to a common second substrate 212. It should be appreciated, however, that the first electrical connectors 110 can alternatively be mounted to different substrates if desired, such that the first electrical connectors 110 can be mounted to at least the first common substrate 112, and the second and third electrical connectors 210, 210A can be mounted to at least the second common substrate 212. The first and second substrates 112 and 212 can be configured as printed circuit boards in accordance with the illustrated embodiments. The first electrical connectors 110 and second and third electrical connectors 210, 210A are configured to be mated so as to establish an electrical connection between the first and second substrates 112 and 212. In accordance with the illustrated embodiment, the third electrical connectors 210A are rearwardly offset with respect to the second electrical connectors 210.

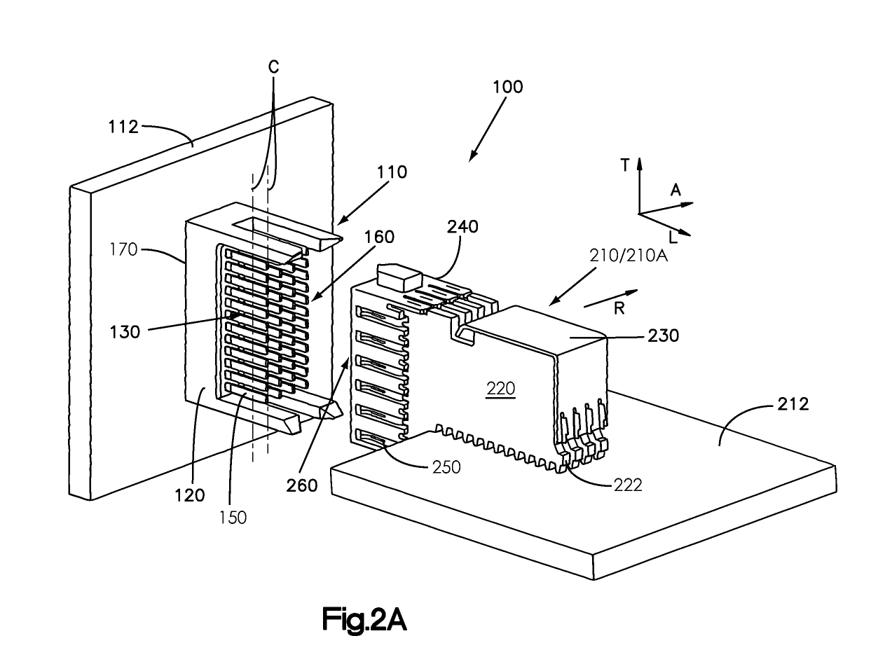

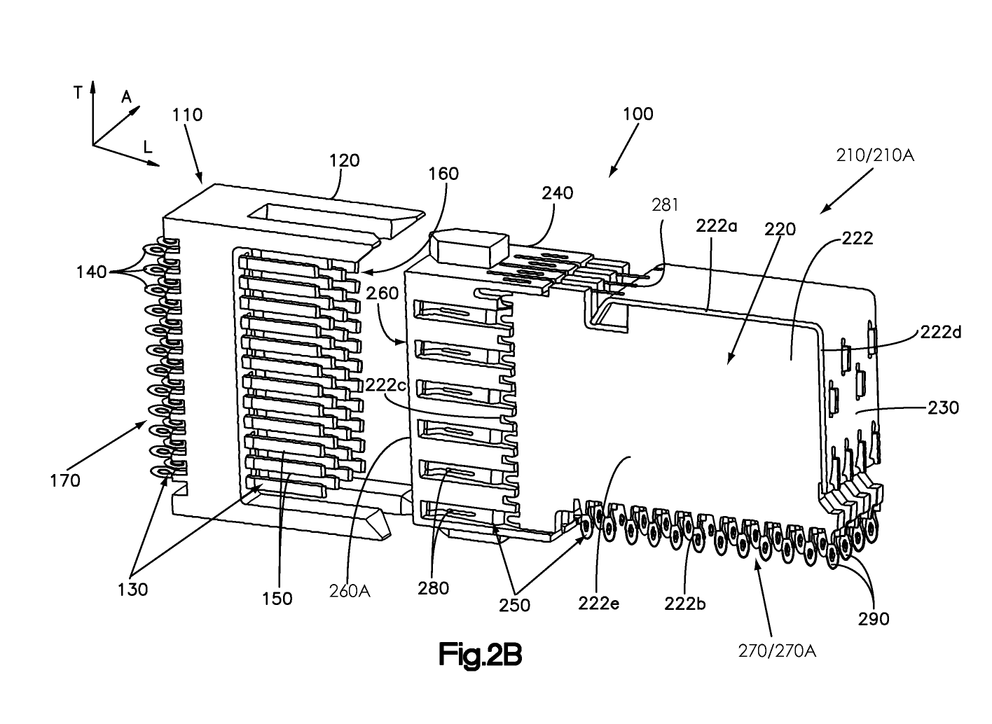

Referring to FIGS. 2A-B, the first electrical connectors 110 and second and third electrical connectors 210, 210A can be constructed in accordance with any embodiment as desired, for instance as described in U.S. Pat. No. 7,762,843, issued Jul. 27, 2010, U.S. patent application Ser. No. 12/197,434, filed Aug. 25, 2008, and U.S. patent application Ser. No. 12/140,810 filed Jun. 17, 2008, the disclosure of each of which is hereby incorporated by reference as if set forth in its entirety herein.

In accordance with the illustrated embodiment, the first electrical connector 110 can include a dielectric or electrically insulative first connector housing 120 that carries a first plurality of electrical contacts 130, which can include signal contacts and ground contacts. The first electrical connector 110 defines a mating face or interface 160 that is configured to mate with the second or third electrical connectors 210, 210A, and a mounting interface 170 that is configured to be mounted to the underlying first substrate 112 (FIG. 2A). In accordance with the illustrated embodiment, the first mating interface 160 is opposed to the mounting interface 170 along a longitudinal direction L. Likewise, each of the first plurality of electrical contacts 130 defines a first mating end 150 disposed proximate to the first mating interface 160 and a longitudinally opposed first mounting end 140 (FIG. 2B) disposed proximate to the mounting interface 170. The first mating ends 150 are configured to electrically connect to complementary second mating ends of the electrical contacts of the second and third electrical connectors 210, 210A when the first electrical connectors 110 are mated with second and third electrical connectors 210, 210A. The first mounting ends 140 (FIG. 2B) can be configured as press-fit tails, surface mount tails, fusible elements such as solder balls, or otherwise configured so as to electrically connect to electrical traces of the underlying first substrate 112 (FIG. 2A). Any suitable dielectric material, such as air or plastic, may be used to isolate the first plurality of electrical contacts 130 from one another. The first plurality of electrical contacts 130 can be overmolded by the first connector housing 120 or stitched into the first connector housing 120 as desired. In accordance with the illustrated embodiment, the first plurality of electrical contacts 130 may extend along columns or column directions C that are spaced along a lateral direction A that is substantially perpendicular with respect to the longitudinal direction L. The first plurality of electrical contacts 130 of a given column are spaced along a transverse direction T that is substantially perpendicular to the longitudinal and lateral directions L and A, respectively.

In accordance with the illustrated embodiment, the transverse direction T is oriented vertically, and the longitudinal and lateral directions L and A are oriented horizontally, though it should be appreciated that the orientation of the connector assembly 100 can vary during use. The first electrical connectors 110 and first and second electrical connectors 210, 210A are configured to be mated along a longitudinally forward insertion direction, and unmated along an opposed longitudinally rearward direction.

For the purposes of clarity, the same or equivalent elements in the various embodiments illustrated in the drawings have been identified with the same reference numerals. Certain terminology is used in the following description for convenience only and is not limiting. The words “right” and “left”, “upper” and “lower”, and “front and rear” designate directions in the drawings to which reference is made. The words “inward”, “inwardly”, “outward”, “outwardly,” “upward,” “upwardly,” “downward,” and “downwardly” refer to directions toward and away from, respectively, the geometric center of the device and designated parts thereof. The terminology intended to be non-limiting includes the above-listed words, derivatives thereof and words of similar import.

In accordance with the illustrated embodiment, the first mating interface 160 of the first electrical connector 110 is disposed proximate to the longitudinal front end of the first connector housing 120, and the mounting interface 170 of the first electrical connector 110 is disposed proximate to the longitudinal rear end of the first connector housing 120. Thus, the mating interface 160 is oriented substantially parallel with respect to the mounting interface 170, and the first mating ends 150 of the first plurality of electrical contacts 130 likewise extend substantially parallel with respect to the first mounting ends 140 (FIG. 2B). Accordingly, the first electrical connector 110 can be referred to as a vertical electrical connector, and the first plurality of electrical contacts 130 can be referred to as vertical electrical contacts. It should be appreciated that the first electrical connector 110 can alternatively be configured as a right-angle electrical connector, whereby the first mating interface 160 extends substantially perpendicular to the mounting interface 170, and the plurality of first electrical contacts 130 can likewise be configured as right-angle electrical contacts whereby the first mating ends 150 extend substantially perpendicular with respect to the first mounting ends 140 (FIG. 2A). Furthermore, the first plurality of electrical contacts 130 are configured as header contacts that are configured to plug into, or be received by, respective receptacle contacts of the second and third electrical connectors 210, 210A. The first electrical connector 110 can thus be referred to as a header connector. Alternatively, the first electrical connector 110 can be configured as a receptacle connector whose first electrical contacts 130 are configured to receive the complementary second electrical contacts of the second or third electrical connectors 210, 210A.

With continued reference to FIGS. 2A and 2B, each of the second or third electrical connectors 210, 210A may include a dielectric or electrically insulative second connector housing 240 and a plurality of second electrical contacts 250 that are carried by the connector housing 240. In accordance with the illustrated embodiment, the second or third electrical connectors 210, 210A includes a plurality of leadframe assemblies 220, each including a leadframe housing 222 that carries the plurality of the second electrical contacts 250. Each leadframe housing 222 can be made from a dielectric or electrically insulative material. In accordance with one embodiment, the leadframe assemblies 220 can be configured as insert molded leadframe assemblies (IMLAs), whereby the leadframe housing 222 is overmolded onto the second electrical contacts 250. Alternatively, the second electrical contacts 250 can be stitched or otherwise fixed in the leadframe housing 222.

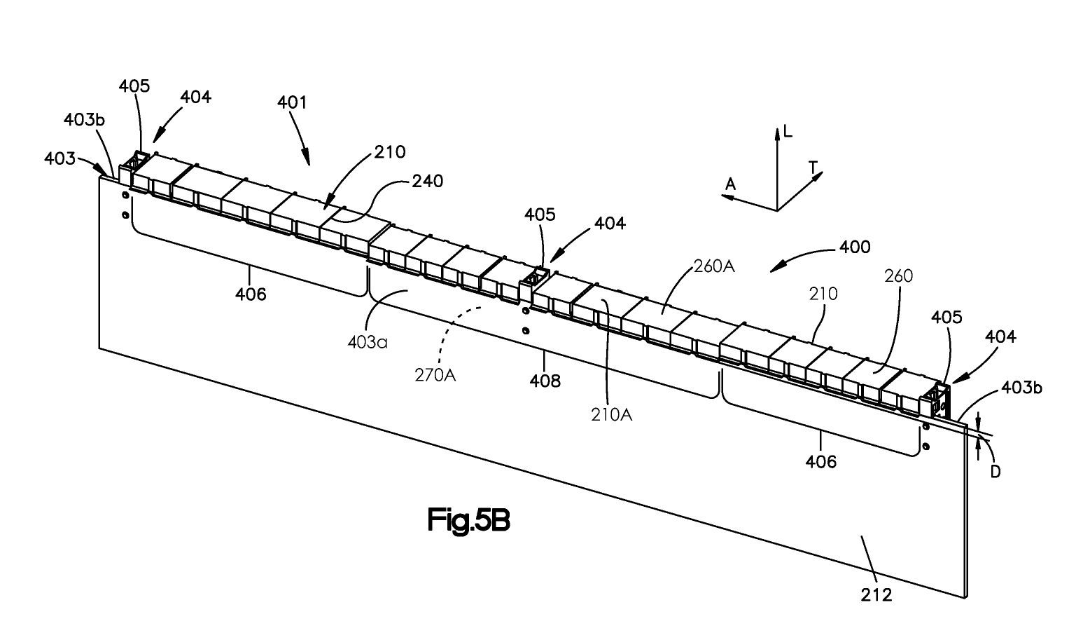

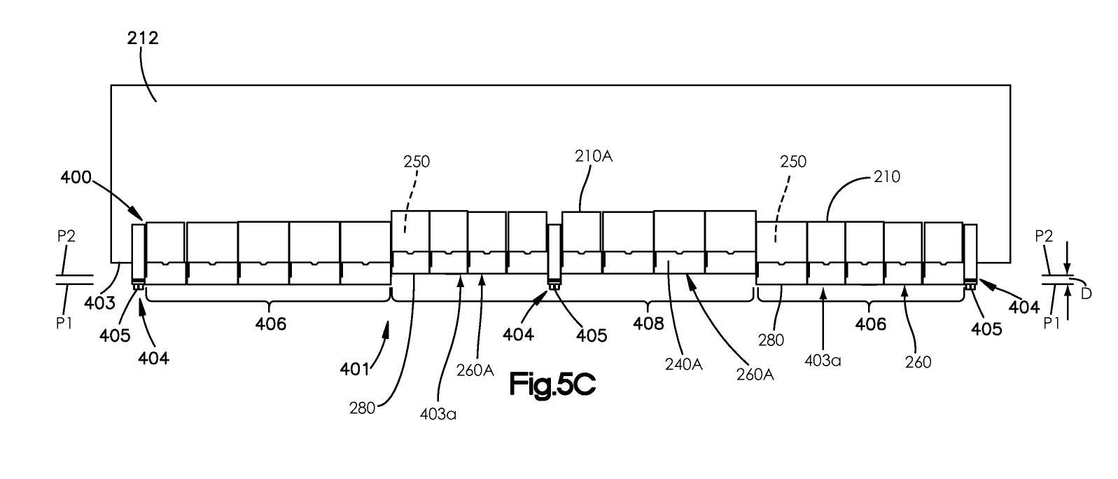

Referring to FIG. 2B, each leadframe housing 222 defines a transverse top end 222a and an opposed bottom end 222b, a longitudinal front end 222c and an opposed rear end 222d, and laterally opposed sidewalls 222e. The second and third electrical connectors 210, 210A each define a second mating face or interface 260 disposed proximate to the longitudinal front end of the connector housing 240 that is configured to mate with the first mating interface 160 of the first electrical connector 110, and a second mounting interface 270 disposed proximate to the transverse bottom end 222e of the leadframe housing 222 that is configured to be mounted onto the underlying substrate 212 (FIG. 5B). The third electrical connector 210A may define a third mating face or interface 260A and a third mounting interface 270A. The second electrical connector 210 and the third electrical connector 210A may be identical from one another, may be different from one another, and are both configured to be mounted immediately adjacent to one another along the same edge of the same underlying substrate 212. As shown in FIG. 5C, the second mating face or interface 260 lies in a first plane P1, the third mating face or interface 260A lies in a second plane P2, the first plane P1 is spaced from the second plane P2 by offset distance D, and the first plane P1 is parallel to the second plane P2.

Referring to FIG. 2B, second electrical contacts 250 each define respective second mating ends 280 that extend longitudinally forward from the longitudinal front end 222c of the corresponding leadframe housing 222 at a location proximate to the second or third mating interfaces 260, 260A. The second mating ends 280 are configured to mate, or electrically connect, with the respective first mating ends 150 of the complementary first plurality of electrical contacts 130 of the first electrical connectors 110. The second electrical contacts 250 further define respective second mounting ends 290 that extend down from the bottom end 222b of the corresponding leadframe housing 222 at a location proximate to the second or third mounting interfaces 270, 270A. The mounting ends 290 are configured to electrically connect electrical traces of the underlying second substrate 212. Any suitable dielectric material, such as air or plastic, may be used to isolate the right angle second electrical contacts 250 from one another. The mounting ends 290 can include press-fit tails, surface mount tails, or fusible elements such as solder balls.

The leadframe assemblies 220 can be spaced apart from each other along a lateral row direction A, and the second electrical contacts 250 of each leadframe assembly 220 can be spaced apart along a transverse column direction T, such that the second electrical contacts 250 of adjacent leadframe assemblies 220 are arranged in an array of spaced apart, substantially parallel transverse columns. The second or third electrical connectors 210, 210A may include an organizer 230 that retains the leadframe assemblies 220 in their desired orientation in the connector housing 240, for instance via slits 281 that are defined in the organizer 230. The organizer 230 can be electrically insulative or electrically conductive as desired.

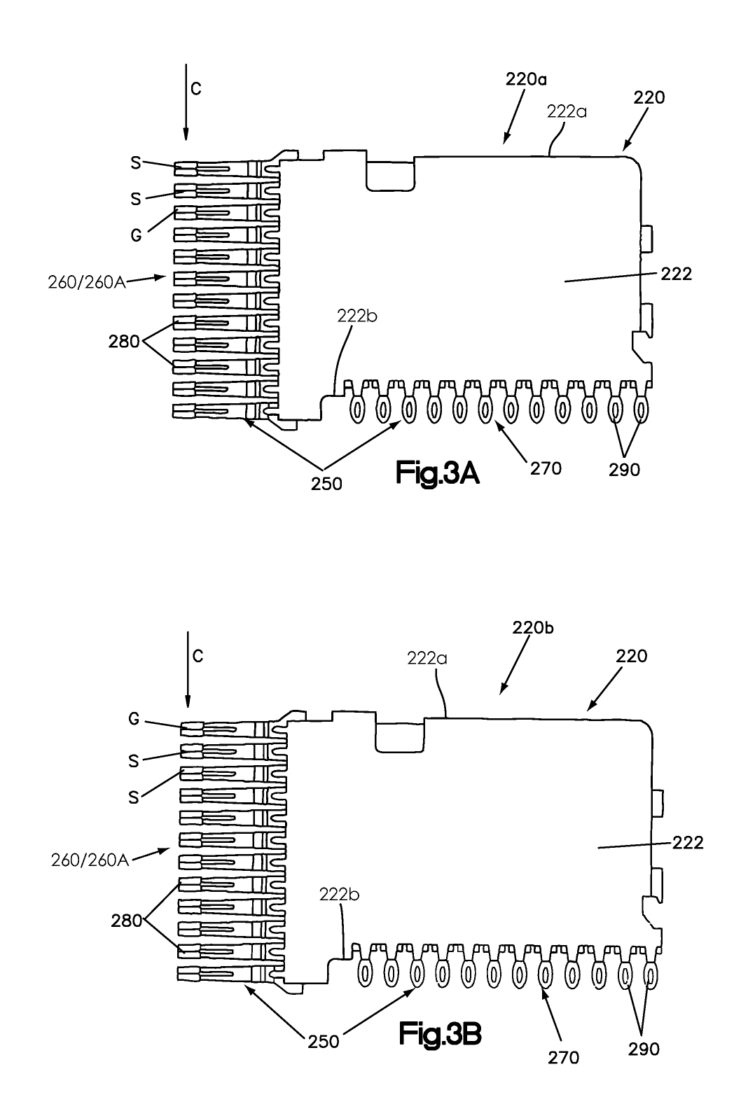

As shown in FIGS. 3A and 3B, the second electrical contacts 250 can include a plurality of signal contacts S and a plurality of ground contacts G. The second and third electrical connectors 210, 210A (FIGS. 2A and 2B) can include two different types of leadframe assemblies 220a and 220b that can be alternately arranged along a row direction. As shown in FIG. 3A, the first type 220a of leadframe assembly 220 can define an arrangement of the second electrical contacts 250 in a repeating S-S-G pattern along the first mating interface 260 or second mating interface 260A between the top and the bottom ends 222a and 222b of the leadframe housing 222, wherein “G” represents a ground contact and “S” represents a signal contact. The second type 220b of leadframe assembly 220 can define an arrangement of the second electrical contacts 250 in a repeating G-S-S pattern along the first mating interface 260 or the second mating interface 260A between the top and the bottom ends 222a and 222b of the leadframe housing 222. Thus, the first and second types 220a and 220b of leadframe assemblies 220 can define different patterns of signal and ground contacts. Alternatively, the types 220a and 220b of leadframe assemblies 220 can define the same pattern of signal and ground contacts. Adjacent pairs of signal contacts S of each leadframe assembly 220 can define differential signal pairs, or the signal contacts S can alternatively be single ended. It should be further appreciated that the first mating interface 260 or the second mating interface 260A can define an open pin field, such that the ground contacts G can alternatively be provided as signal contacts that can have a data transfer speed that is different (for instance less) than that of the other signal contacts S.

Referring to FIG. 2B, the first and second mating interfaces 260, 260A of the second or third electrical connectors 210, 210A are oriented substantially perpendicular with respect to the second and third mounting interfaces 270, 270A, and the second mating ends 280 of the second electrical contacts 250 are oriented substantially perpendicular with respect to the second mounting ends 290. Thus, the second or third electrical connectors 210, 210A can be referred to as a right-angle electrical connectors, and the second electrical contacts 250 can be referred to as right-angle electrical contacts. It should be appreciated that the second or third electrical connectors 210, 210A can alternatively be configured as a vertical electrical connector similar to the first electrical connector 110 described above, whereby the first and second mating interfaces 260, 260A extend substantially parallel to the second or third mounting interfaces 270, 270A and that the second electrical contacts 250 can be configured as vertical contacts whose second mating ends 280 are oriented substantially parallel with respect to the second mounting ends 290. Furthermore, the second mating ends 280 of the second electrical contacts 250 are configured as receptacles that are configured to receive the first mating ends 150 of the complementary first plurality of electrical contacts 130 of the first electrical connector 110. Thus, the second or third electrical connectors 210, 210A can be referred to as receptacle connectors. Alternatively, the second electrical contacts 250 can be configured as header contacts whose second mating ends 280 are configured to be plugged into, or received by, complementary receptacle contacts.

In accordance with the illustrated embodiment (see FIG. 1), the first electrical connector 110, second electrical connector 210, and third electrical connector 210A can be configured to be mated such that the respective first and second substrates 112 and 212 extend orthogonal to each other. Alternatively, the first and second substrates 112 and 212 can extend parallel to each other when the first electrical connectors 110 are mated with second and third electrical connectors 210, 210A. Accordingly, it should be appreciated that the first and second substrates 112 and 212 can be arranged in an orthogonal or a co-planar configuration.

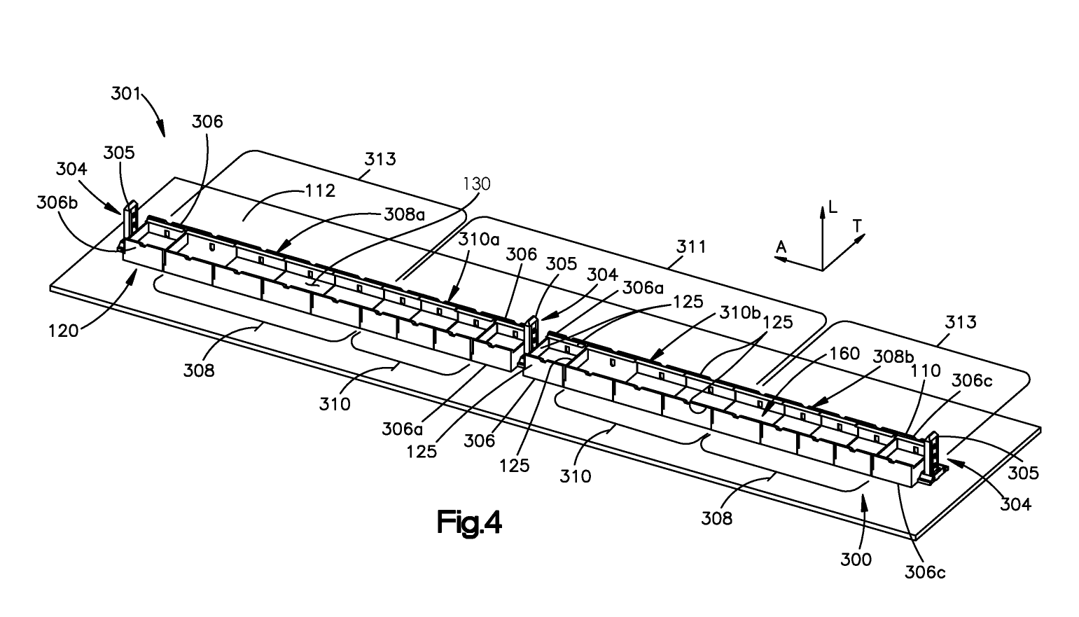

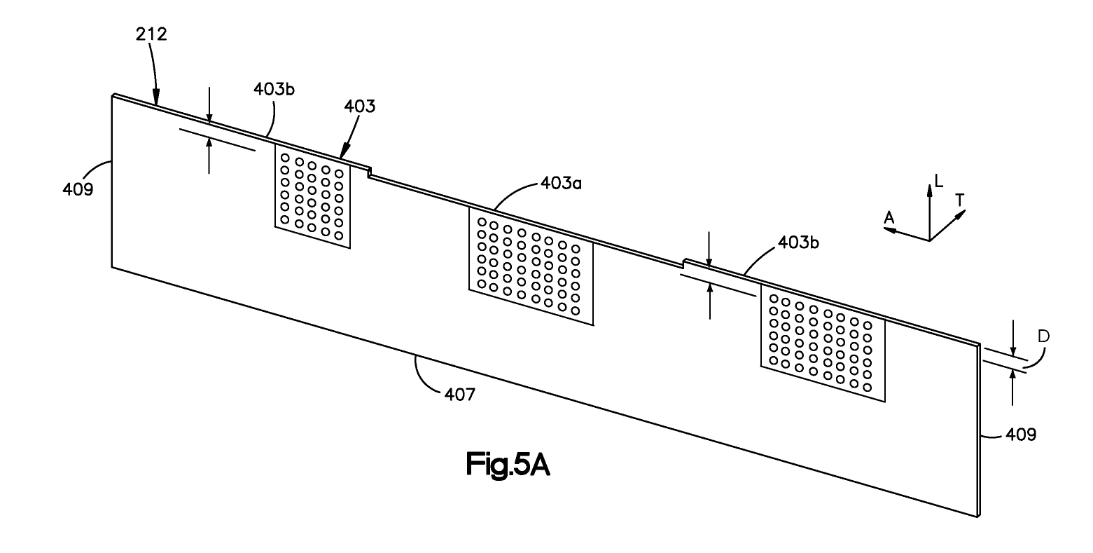

Referring now to FIGS. 1 and 4, a first electrical component 301 includes the first array 300 of first electrical connectors 110 configured to be mounted onto the first substrate 112 in the manner described above. In particular, the first mounting ends 140 (FIG. 2B) of the first electrical connectors 110 are press-fit into plated through-holes formed in the first substrate 112, so as to be placed in electrical communication with the electrical traces running through or along the first substrate 112. As illustrated, the first electrical component 301 can include at least one guide member 304, such as a plurality of guide members 304 associated with the first electrical connectors 110. The guide members 304 can be configured as desired, and are illustrated as posts 305, that extend longitudinally outward from the first substrate 112 along a direction substantially parallel to the insertion direction. The posts 305 are illustrated as disposed on opposed lateral sides of the first electrical connectors 110 of the first array 300, and disposed between adjacent first electrical connectors 110. The posts 305 can extend from the surface of the first substrate 112, or can extend from a respective one or more of the first electrical connectors 110, to a location longitudinally forward with respect to the first mating interfaces 160 of the first electrical connectors 110. The guide members 304 are configured to engage complementary guide members 404 (see FIGS. 5B-C) associated with the second or third electrical connectors 210, 210A so as to provide rough alignment between the first electrical connectors 110 and the second and third electrical connectors 210, 210A as the first electrical connectors 110 and the second and third electrical connectors 210, 210A are mated to each other. It should be appreciated that the alignment members 304 are configured as posts 305 in accordance with one embodiment, and that the alignment members 304 can alternatively be configured as desired to mate with a complementary alignment member so as to facilitate alignment of the first electrical connectors 110 with complimentary second and third electrical connectors 210, 210A.

In accordance with the illustrated embodiment, the first array 300 defines a linear array in the lateral direction A, though it should be appreciated that the first electrical connectors 110 can alternatively be arranged in any geometrical configuration as desired so as to mate with complementary electrical connectors of the second substrate. For example, regions of the first array of electrical connectors can be offset from each other, for example along the transverse direction T. As shown in FIGS. 1 and 4, the first substrate 112 may be substantially flat so that the first electrical connectors 110 in the first plurality 308 of first electrical connectors 110 and the first electrical connectors 110 in the second plurality 310 first electrical connectors 110 each lie in a first common plane and each have first mating faces or interfaces 160 that lie in a second common plane that is coplanar with the first common plane. For instance, in accordance with the illustrated embodiment, the mating ends 150 of the electrical contacts 130 of the first and second pluralities 308 and 310 of the first connectors 110 are substantially aligned with each other along the lateral direction in the first common plane, wherein the lateral direction is substantially perpendicular to the insertion direction. Thus, the first and second pluralities 308 and 310 of the first connectors 310 are aligned in the first and second common planes, which are coplanar with each other.

As illustrated in FIG. 4, the first connector housings 120 of a select at least one, such as a plurality 306a-c of the first electrical connectors 110 of the first array 300, can include four side walls 125, including pair of transversely opposed walls and a pair of laterally opposed walls, that substantially surround the first electrical contacts 130 retained in the respective connector housings 120. One 306 of the plurality 306a-c of first electrical connectors 110 can be disposed adjacent the alignment members 304, and the side walls 125 protect the first electrical contacts 130 as the complimentary first electrical connectors 110 are mated with second and third electrical connectors 210, 210A (FIG. 1). The side walls 125 more precisely align the first electrical connectors 110 with respective ones of the second and third electrical connectors 210, 210A and their corresponding second electrical contacts 250 as the connectors are mated, and to protect the first mating ends 150 of the first electrical contacts 130 from bending. It should be appreciated that the connector housings 120 of at least one, such as a plurality, up to all, of the first electrical connectors 110 can be constructed as described with respect to the plurality 306 (FIGS. 1 and 4) of first electrical connectors 110.

In accordance with the illustrated embodiment shown in FIG. 1, each of the first electrical connectors 110 of the first plurality 308 of first electrical connectors 110 are configured to mate with complimentary second electrical connectors 210 of the third plurality 406 of first electrical connectors 210.

As shown in FIG. 4, the second plurality 310 of first electrical connectors 110 is disposed laterally inward with respect to the first plurality 308 of first electrical connectors 110. Furthermore, the second plurality 310 of first electrical connectors 110 can be separated into two equal groups of first electrical connectors 110 separated by one of the plurality 306 of first electrical connectors 110. Thus a first group 310a of the second plurality 310 of first electrical connectors 110 can be disposed between a select one or more, such as select inner one 306, 306a, of the plurality 306 of first electrical connectors 110. A second group 310b of the second plurality 310 of first electrical connectors 110 can be disposed between the select one 306a of the plurality 306 of first electrical connectors 110 and a second group 308b of the first plurality 308 of first electrical connectors 110. The first group 308a of the first plurality 308 of first electrical connectors 110 can be disposed between the first group 310a of the second plurality 310 of first electrical connectors 110 and a first select one, such as a first outer one 306b, of the plurality 306 of first electrical connectors 110. The second group 308b of the first plurality 308 of first electrical connectors 110 can be disposed between the second group 310b of the second plurality 310 of first electrical connectors 110 and a second select one, such as a second outer one 306c, of the plurality 306 of first electrical connectors 110. The first electrical connectors 110 of the second plurality 310 can be aligned with at least one, such as a plurality, up to all, of the first electrical connectors 110 one or both of the first of the first plurality 308 of first electrical connectors 110 with respect to the lateral direction.

Referring now to FIG. 5B, the second electrical component 401 includes the second array 400 of second and third electrical connectors 210, 210A configured to be mounted onto the second substrate 212 in the manner described above. In particular, the second mounting ends 290 (FIG. 2B) of the second or third electrical connectors 210, 210A are press-fit into plated through-holes formed in the second substrate 212, so as to be placed in electrical communication with the electrical traces running through or along the second substrate 212. Accordingly, as shown in FIG. 1, when the first electrical connectors 110 and second and third electrical connectors 210, 210A are mated, the first and second substrates 112 and 212 can be placed in electrical communication with each other. As illustrated in FIG. 5B, the second electrical component 401 can include at least one guide member 404, such as a plurality of guide members 404 associated with the fourth plurality 408 of second electrical connectors 210. The guide members 404 can be configured as desired, and are illustrated as silos 405, that extend longitudinally outward from the second substrate 212 along a direction substantially parallel to the longitudinal insertion direction. The guide members 404 are configured to engage the complementary guide members 304 (FIG. 1) associated with the first electrical connectors 110 so as to provide rough alignment between the first electrical connectors 110 and the second and third electrical connectors 210, 210A as the first electrical connectors 110 and the second and third electrical connectors 210, 210A are mated to each other. As shown in FIG. 5B, it should be appreciated that the alignment members 404 are configured as silos 405 in accordance with one embodiment, and that the alignment members 404 can alternatively be configured as desired to mate with a complementary alignment member so as to facilitate alignment of the second and third electrical connectors 210, 210A (FIG. 1) with complimentary first electrical connectors 110.

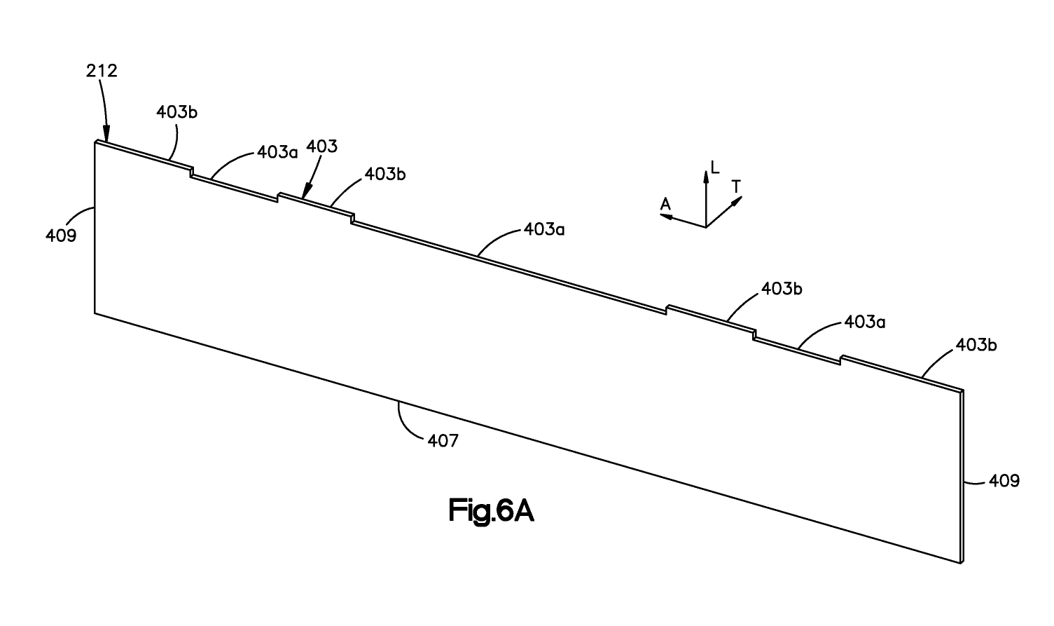

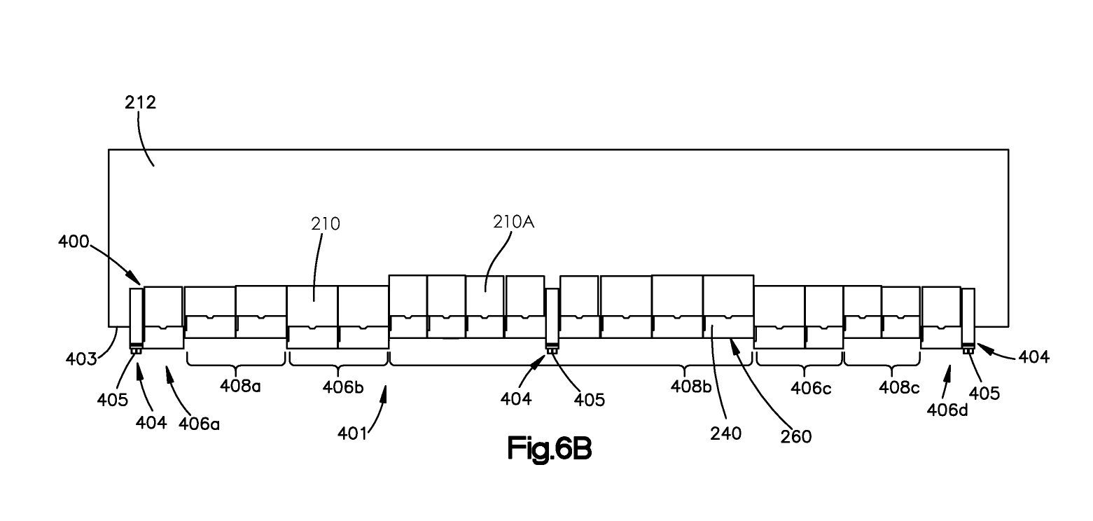

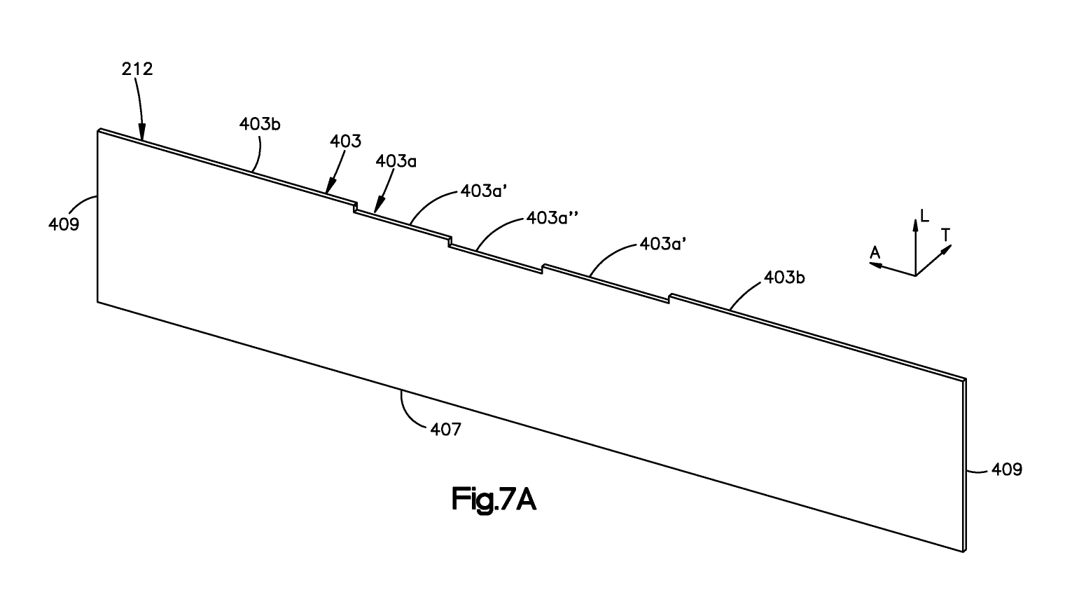

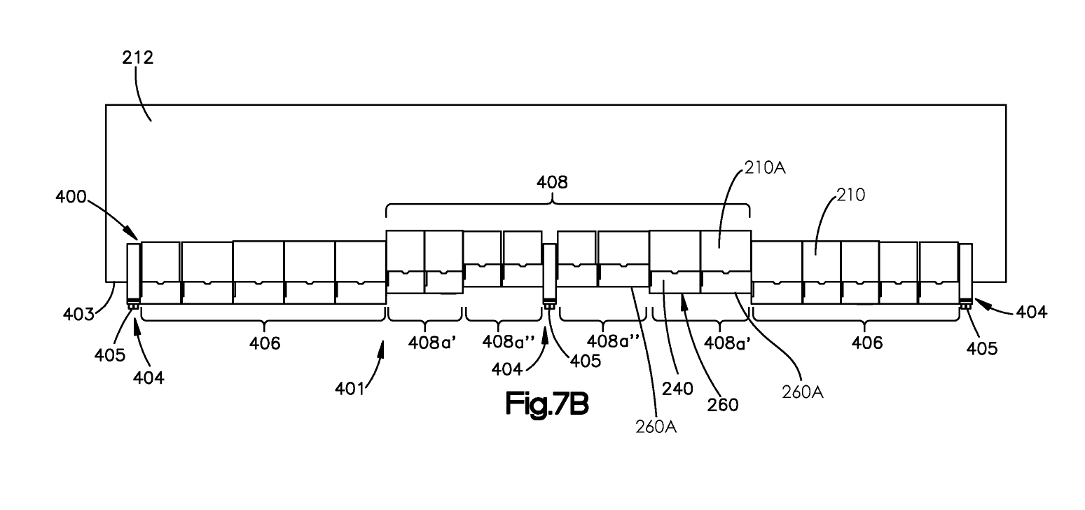

The second substrate 212 defines a longitudinally front edge 403, an opposed longitudinally rear edge 407, and a pair of laterally opposed side edges 409. The front edge 403 defines at least one recessed first region 403a that is offset longitudinally inward, or longitudinally recessed, with respect to adjacent, or second remainder regions 403b of the front edge 403. The second regions 403b are thus longitudinally outwardly displaced with respect to the recessed first regions 403a of the front edge 403. Accordingly, the recessed first region 403a is spaced from an outwardly displaced second region 403b along a lateral direction, and inwardly offset with respect to the second region 403b along a longitudinal direction, wherein the plane of the substrate 212 is defined by the lateral and longitudinal directions. It can thus be said that the first region 403a is offset along a first direction with respect to a second region 403b that is disposed adjacent the first region along a second direction, wherein the first and second directions are substantially perpendicular to each other and define the plane of the second substrate. In accordance with the illustrated embodiment, the recessed first region 403a is a laterally inner region, and the second regions 403b are laterally outer regions extending laterally outward from laterally opposed ends of the recessed region 403a. It should be appreciated that the front edge 403 can include any number of distinct recessed regions 403a as desired that can be located anywhere along the front edge 403 of the second substrate 212 as desired (see FIGS. 6A-B). Furthermore, at least one up to all of the recessed regions 403a can define a substantially constant offset, or can define a variable (e.g., stepped) offset (see FIGS. 7A-B).

As shown in FIGS. 5B, the second electrical connectors 210 of the second array 400 can be mounted onto the front edge 403 of the second substrate 212. At least one, such as one of a third plurality 406 of second electrical connectors 210, may be mounted onto the second region 403b of the front edge 403. The second electrical connectors 210 can be mounted onto the substrate 212 at a consistent location relative to the edge 403. The third electrical connectors 210A of the fourth plurality 408 are longitudinally recessed with respect to the second electrical connectors 210 of the third plurality 406 of second electrical connectors 210 along the insertion direction.

As shown in FIG. 5C, the third mating interfaces 260A of the third electrical connectors 210A of the fourth plurality 408 are longitudinally recessed with respect to the second mating interfaces 260 of the second electrical connectors 210 of the third plurality 406 along the insertion direction. Additionally, the second mating ends 280 (FIG. 2B) of at least one of the second electrical contacts 250 of the fourth plurality 408 of third electrical connectors 210A is longitudinally recessed with respect to the at least one of the second mating ends 280 of second electrical contacts 250 of the second electrical connectors 210 along the insertion direction. The recessed region 403a of the edge 403 can be offset with respect to the adjacent remainder regions 403b through an offset distance D greater than approximately 0.25 mm, such as greater than approximately 0.5 mm, and less than the wiping distance of the second electrical contacts 250 of the second or third electrical connectors 210, 210A when mated with the first electrical contacts 130 of the first electrical connector 110 (FIG. 1). In accordance with one embodiment, the offset distance D can be between approximately 0.25 mm and approximately 1.0 mm, such as between approximately 0.5 mm and approximately 0.75 mm. Furthermore, the offset distance D can be equal to the recess of the first region 403a of the front edge 403 of the second substrate 212 with respect to the second region 403b.

Alternatively, the edge 403 of the second substrate 212 can be smooth and straight, and thus not include a recessed region 403a. The fourth plurality 408 of the third electrical connectors 210A can be set back, or offset, from the edge 403 of the second substrate 212 and with respect to the third plurality 406 of second electrical connectors 210 a suitable distance as described above with respect to the offset of the recessed region 403a. For example, mounting locations, such as plated through holes, of the second substrate 212 that are connected to the second mounting ends 290 of the second electrical contacts 250 of the third electrical connectors 210A can be offset longitudinally rearward with respect to the second mounting locations, such as plated through holes, that are configured to electrically connect to the second mounting ends 290 of the second electrical contacts 250 of the second electrical connectors 210 of the fourth plurality 408. It should be further appreciated that the second mating ends 280 of the second electrical contacts 250 of the third plurality 406 of the second electrical connectors 210 can be longer along the longitudinal insertion direction than the second mating ends 280 of the second electrical contacts 250 of the fourth plurality 408 of third electrical connectors 210A. Accordingly, the second mounting ends 290 of the second electrical contacts 250 of the third and fourth pluralities 406 and 408 of the second and third electrical connectors 210, 210A can be mounted onto laterally aligned locations on the second substrate 212, such that the second mating ends 280 of the second electrical contacts 250 of the fourth plurality 408 of third electrical connectors 210A is longitudinally recessed with respect to the second mating ends 280 of the second electrical contacts 250 of the third plurality 406 of second electrical connectors 210. Alternatively, the second array 400 of second and third electrical connectors 210, 210A can be constructed of just second or third electrical connectors 210, 210A all of which are substantially the same size (e.g., length in the insertion direction), that are mounted such that the second array 400 is linearly aligned with respect to the edge 403 of the second substrate 212, with some, up to all of the second or third electrical connectors 210, 210A having second mating ends 280 of various lengths.

In accordance with the illustrated embodiment, the third plurality 406 of second electrical connectors 210 includes a first number of columns of second electrical contacts 250 (e.g., leadframe assemblies 220 of the type described above), and the fourth plurality 408 of third electrical connectors 210A a second number of columns of second electrical contacts 250 (e.g., leadframe assemblies 220 of the type described above). In accordance with the illustrated embodiment, the first number of columns is less than the second number of columns, though the first number of columns can alternatively be greater than or equal to the second number of columns. For instance, the first number of columns can be twelve, and the second number of columns can be sixteen. In general, the number of columns (defined by the differential signal pairs) is the same for the first electrical connectors 110 and the second electrical connectors 210, third electrical connectors 210A, or the plurality 306.

It is recognized that the insertion force required to mate complementary first electrical connectors 110 and second and third electrical connectors 210, 210A increases with increasing numbers of the associated first or second electrical contacts 130 and 250, respectively, that are mated. Because the second mating ends 280 of the fourth plurality 408 of third electrical connectors 210A of the second array 400 are recessed with respect to the second mating ends 280 of the third plurality 406 of electrical connectors 210, when the first and second arrays 300 and 400 are mated, the second mating ends 280 of the third plurality 406 of second electrical connectors 210 of the second array 400 engage the complimentary first mating ends 150 of the first array 300 before the second mating ends 280 of the fourth plurality 408 of third electrical connectors 210A engage the first mating ends 150 of the second plurality 310 of first electrical connectors 110. Accordingly, because the number of second mating ends 280 of the second electrical contacts 250 of the second electrical connectors 210 in the second array 400 that initially engage the first mating ends 150 of the first electrical contacts 130 of the first electrical connectors 110 in the first array 300 is reduced with respect to an otherwise configured second array 400 of second and third electrical connectors 210, 210A that does not include any recessed electrical connectors, the peak insertion force (or greatest insertion force required when mating the arrays 300 and 400 of first electrical connectors 110 and 210, respectively) is correspondingly reduced when mating the first electrical connectors 110 and 210 of the first and second arrays 300 and 400.

It should be appreciated that while the first electrical connectors 110 of the first array 300 of are all depicted as having a constant transverse height with respect to the first substrate 112, one or more of the first electrical connectors 110 can be have a height that is offset or reduced with respect to one or more other of the first electrical connectors 110. For example, one or more first electrical connectors 110 can be mounted on a raised portion (not shown) of the first substrate 112, the raised portion extending transversely upward, or one or more first electrical connectors 110 can be configured with longer first mounting ends 150 than the one or more other first electrical connectors 110.

It should further be appreciated that the first electrical connectors 110, second electrical connectors 210, and third electrical connectors 210A of the first and second arrays 300 and 400 are illustrated as being mounted immediately adjacent to one another on the respective first and second substrates 112 and 212, with little or no space in between the respective connector housings of the first, second, and third electrical connectors 110, 210, 210A.

Referring now to FIG. 6A, the at least one first recessed region 403a of the front edge 403 can define a plurality of recessed regions 403a, and the at least one remainder region 403b of the front edge 403 can define a plurality of second remainder regions 403b disposed adjacent to the recessed regions 403a. For instance, at least one of the remainder regions 403b can extend between a pair of recessed regions 403a. As described above, the recessed regions 403a are offset longitudinally inward, or longitudinally recessed, with respect to the adjacent remainder regions 403b of the front edge 403. Thus, the second remainder regions 403b are longitudinally outwardly displaced with respect to the recessed first regions 403a of the front edge 403. In accordance with the illustrated embodiment, the recessed first region 403a is a laterally inner region, and the second regions 403b are laterally outer regions extending laterally outward from laterally opposed ends of the recessed region 403a. It should be appreciated that the front edge 403 can include any number of distinct recessed regions 403a as desired that can be located anywhere along the front edge 403 of the second substrate 212 as desired. One or more up to all of the recessed regions 403a can define a substantially constant longitudinal offset distances with respect to one or more up to all of the remainder regions 403b. Alternatively, one or more up to all of the recessed regions 403a can define a different longitudinal offset distances with respect to one or more up to all of the remainder regions 403b.

Accordingly, referring also to FIG. 6B, the second electrical component 401 can include the second array 400 of staggered or offset second and third electrical connectors 210, 210A configured to be mounted onto the second substrate 212. The fourth plurality 408 of third electrical connectors 210A includes at least one group, such as a plurality of groups 408a, 408b, 408c, of at least one second electrical connector 210A (including a plurality of second electrical connectors 210A) mounted onto the front edge 403 of the second substrate 212 at a corresponding one of the first recessed regions 403a. Furthermore, the third plurality 406 of second electrical connectors 210 includes at least one group, such as a plurality of groups 406a 406b, 406c, 406d of at least one second electrical connector 210 (including a plurality of second electrical connectors 210) mounted onto the front edge 403 of the second substrate 212 at a corresponding one of the second regions 403b. Thus, the second array 400 can define a plurality of groups 408a, 408b, 408c of at least one third electrical connector 210A such as a plurality of third electrical connectors 210A that are offset with respect to a plurality of groups 406a, 406b, 406c. 406d of second electrical connectors 210, such as a plurality of second electrical connectors 210. One or more of the groups 406a-c can define a substantially constant longitudinal offset distances with respect to one or more up to all of groups 408a-d. It should be appreciated that the third mating interfaces 260A, and second mating ends 280, of the offset third electrical connectors 210A of the groups 408a-c of third electrical connectors 210A are longitudinally recessed with respect to the second mating interfaces 260, and second mating ends 280, of the second electrical connectors 210 of the electrical connectors of the groups 406a-d of second electrical connectors 210 along the insertion direction. Furthermore, one or more up to all of the groups 406a-c can define a different longitudinal offset distances with respect to both each other and one or more up to all of the groups 408a-d. It should be appreciated that a third electrical connector is spaced from an outwardly displaced second electrical along a lateral direction, and inwardly offset with respect to the second region 403b along a longitudinal direction, wherein the plane of the substrate to which the second and third electrical connector as mounted is defined by the lateral and longitudinal directions. It can thus be said that the first region 403a is offset along a first direction with respect to a second region 403b that is disposed adjacent the first region along a second direction, wherein the first and second directions are substantially perpendicular to each other and define the plane of the second substrate.

Referring now to FIG. 7A, the front edge 403 can define a first recessed region 403a′ and a second recessed region 403a″ that are each offset longitudinally inward, or longitudinally recessed, with respect to the adjacent remainder regions 403b at different offset distances. Thus, the second recessed region 403a″ can define an offset that is greater than the offset of the first recessed region 403a′. Further, the second recessed region 403a″ can be nested in the first recessed region 403a′ as illustrated. Alternatively, the second recessed region 403a″ can be spaced from the first recessed region 403a′ as described above with respect to the recessed regions 403a with reference to FIG. 6A. It should be appreciated that the front edge 403 can include any number of recessed regions 403a as desired that can be located anywhere along the front edge 403 of the second substrate 212, and can define any offset distance, greater than, equal to, or less than, the offset distance of at least one up to all of the other recessed regions 403a as desired.

Accordingly, referring also to FIG. 7B, the second electrical component 401 can include the second array 400 of second and third electrical connectors 210, 210A configured to be mounted onto the second substrate 212 such that the fourth plurality 408 of third electrical connectors 210A includes at least one group, such as a first group 408a″ of at least one third electrical connector 210A (including a plurality of third electrical connectors 210A) mounted onto the first recessed region 403a′ of the front edge 403, and a second group 408a′ of at least one third electrical connector 210A (including a plurality of third electrical connectors 210A) mounted onto the second recessed region 403a′ of the front edge 403. Thus, the first group 408a″ of third electrical connectors 210A can be recessed from the second group 408a′ of the second electrical connectors 210A with respect to the insertion direction. The second group 408a′ of electrical connectors can, in turn, be recessed from the second electrical connectors 210 of the third plurality 406 of second electrical connectors 210 with respect to the insertion direction. It should be appreciated that the third mating interfaces 260A, and second mating ends 280, of the offset electrical connectors of the first group 408a″ of third electrical connectors 210A are longitudinally recessed with respect to the third mating interfaces 260A, and second mating ends 280, of the offset second electrical connectors 210 of the second group 408a′ of third electrical connectors 210A. The third mating interfaces 260A, and second mating ends 280, of the offset third electrical connectors 210A of the first group 408a′ of third electrical connectors 210A, in turn, are longitudinally recessed with respect to the second mating interfaces 260, and second mating ends 280, of the offset second electrical connectors 210 of the third plurality 406 of second electrical connectors 210.

The embodiments described in connection with the illustrated embodiments have been presented by way of illustration, and the present invention is therefore not intended to be limited to the disclosed embodiments. Furthermore, the structure and features of each the embodiments described above can be applied to the other embodiments described herein, unless otherwise indicated, for example the first and second arrays 300 and 400 of electrical connectors can be constructed using any combination of vertical and/or right angle connectors, header and/or receptacle connectors, and configured in any array geometry.

Another embodiment includes a method to facilitate an electrical connector system that has a reduced insertion force. The method may comprises the step of disclosing to a third party, by an act of providing audible words or a visual depiction fixed in a tangible medium of expression to the third party, a first substrate. For instance, as used herein, the step of disclosing can be direct or with the aid of a machine or a device. Also as used herein, the visual depiction fixed in a tangible medium of expression can be sufficiently permanent or stable to permit it to be perceived, reproduced, or otherwise communicated. The first substrate may include a front edge that defines at least one recessed first region. The at least one recessed first region may be longitudinally recessed with respect to an adjacent, second remainder region of the front edge. Another step may include providing a second electrical connector to the third party, a contract manufacturer of the third party, or an agent of the third party. Another step may include a step of providing a third electrical connector to the third party, a contract manufacturer of the third party, or an agent of the third party. Another step may include a step of disclosing to the third party, by audible words or a visual depiction fixed in a tangible medium of expression, that the third electrical connector mates with a first electrical connector before the third electrical connector mates with a first electrical connector. The second electrical connector is physically attached to a second substrate after the step of providing the second electrical connector, the third electrical connector is physically attached to the second substrate after the step of providing the third electrical connector, the second substrate comprises a front edge that defines at least one recessed first region, and the at least one recessed first region is longitudinally recessed with respect to an adjacent, second remainder region of the front edge. Another step may include disclosing to the third party, by audible words or a visual depiction fixed in a tangible medium of expression, that insertion force of the second substrate is reduced as a result of the recessed first region.

Another method to facilitate an electrical connector system that has a reduced insertion force may include the steps of teaching a third party, by audible words or a visual depiction fixed in a tangible medium of expression, a first electrical component populated with two or more first electrical connectors that lie in a common plane, teaching a third party, by audible words or a visual depiction fixed in a tangible medium of expression, a second electrical component populated with second and third electrical connectors, the third electrical connectors recessed with respect to an edge of the second electrical component, providing a second electrical connector to the third party, a contract manufacturer of the third party, or an agent of the third party, and providing a third electrical connector to the third party, a contract manufacturer of the third party, or an agent of the third party. The second electrical connector and the third electrical connector are both attached to a second substrate, the second substrate comprises copper, which can define an electrical trace, and the third electrical connector mates with a first electrical connector before the second electrical connector mates with another first electrical connector.

A method to facilitate an electrical connector system that has a reduced insertion force may include the steps of teaching a third party, by an act of providing audible words or a visual depiction fixed in a tangible medium of expression to the third party, a first electrical component that has offset second and third electrical connectors and a second electrical component that has first electrical connectors that lie in a first common plane, teaching the third party, by an act of providing audible words or a visual depiction fixed in a tangible medium of expression to the third party, that the first electrical component and the second electrical component have reduced insertion force compared to mating the second electrical component with a similar first electrical component that is otherwise identical to the first electrical component but the second and third electrical connector are not offset, and selling first, second, or third electrical connectors to the third party, a contract manufacturer of the third party, or an agent of the third party, wherein the first, second, or third electrical connectors are connected to a respective first electrical component comprising copper, which can define an electrical trace, or a second electrical component comprising copper, which can define an electrical trace.

Accordingly, those skilled in the art will realize that the invention is intended to encompass all modifications and alternative arrangements included within the spirit and scope of the invention, for instance as set forth by the appended claims.

What is claimed:

1. An array of electrical connectors comprising:
a second electrical connector that defines a second mating face; and
a third electrical connector that defines a third mating face,
wherein the second electrical connector and the third electrical connector are both configured to be mounted on a same edge of a same substrate, the second mating face lies in first plane, the third mating face lies in a second plane, the first plane is spaced from the second plane, the first plane is parallel to the second plane, and the second electrical connector mates with a first electrical connector before the third electrical connector mates with a first electrical connector.

2. The array of electrical connectors as recited in claim 1, wherein the third electrical connector is configured to be mounted along a recessed edge of the same edge of the same substrate.

3. The array of electrical connectors as recited in claim 1, wherein the second electrical connector and the third electrical connector are both right angle daughtercard connectors.

4. An electrical connector assembly comprising:
a first electrical component comprising first electrical connectors; and
a second electrical component comprising second and third electrical connectors, the second and third electrical connectors configured to mate with the first electrical components along an insertion direction;
wherein the first electrical connectors are each aligned in a first common plane and when the first and second electrical components are mated, the second plurality of electrical connectors mate with the second array of electrical connectors before the first plurality of electrical connectors mate with the second array of electrical connectors.

5. A method to facilitate an electrical connector system that has a reduced insertion force comprising the steps of:
disclosing to a third party, by audible words or a visual depiction fixed in a tangible medium of expression, a substrate, the substrate comprising a front edge that defines at least one recessed first region, the at least one recessed first region longitudinally recessed with respect to an adjacent, second remainder region of the front edge;
providing a second electrical connector to the third party, a contract manufacturer of the third party, or an agent of the third party;
providing a third electrical connector to the third party, a contract manufacturer of the third party, or an agent of the third party; and
disclosing to the third party, by an act of providing audible words or a visual depiction fixed in a tangible medium of expression, that the second electrical connector mates with a first electrical connector before the third electrical connector mates with another first electrical connector,

6. The method as recited in claim 5, wherein the second electrical connector is physically attached to a second substrate after the step of providing the second electrical connector, the third electrical connector is physically attached to the second substrate after the step of providing the third electrical connector, the second substrate comprises a front edge that defines at least one recessed first region, and the at least one recessed first region is recessed with respect to an adjacent, second remainder region of the front edge along an insertion direction.

7. The method as recited in claim 6, further comprising the step of disclosing to the third party, by audible words or a visual depiction fixed in a tangible medium of expression, that insertion force of the second substrate is reduced as a result of the recessed first region.

8. The method as recited in claim 6, wherein the first recessed region is recessed with respect to the second remainder region along a longitudinal direction, the first recessed region is spaced from the second remainder region along a lateral direction, and the substrate is substantially planar along the longitudinal and lateral directions.

9. The method as recited in claim 5, further comprising the step of disclosing to the third party, by audible words or a visual depiction fixed in a tangible medium of expression, that insertion force of the second substrate is reduced as a result of the recessed first region.

10. A method to facilitate an electrical connector system that has a reduced insertion force comprising the steps of:
teaching a third party, by audible words or a visual depiction fixed in a tangible medium of expression, a first electrical component populated with two or more first electrical connectors that are aligned in a common plane;
teaching a third party, by audible words or a visual depiction fixed in a tangible medium of expression, a second electrical component populated with second and third electrical connectors, the third electrical connectors recessed with respect to an edge of a second electrical component;
providing a second electrical connector to the third party, a contract manufacturer of the third party, or an agent of the third party,
providing a third electrical connector to the third party, a contract manufacturer of the third party, or an agent of the third party,
wherein the second electrical connector and the third electrical connector are both attached to a substrate, the substrate comprises copper, and the second electrical connector mates with a first electrical connector before the third electrical connector mates with another first electrical connector.

11. The method as recited in claim 10, wherein the third electrical connector is recessed with respect to the second electrical connector along a first direction, the third electrical connector is spaced from the second electrical connector along a second direction that is substantially perpendicular to the first direction, and the substrate is substantially planar along the first and second directions.

12. A method to facilitate an electrical connector system that has a reduced insertion force comprising the steps of:
teaching a third party, by an act of providing audible words or a visual depiction fixed in a tangible medium of expression to the third party, a first electrical component that has offset second and third electrical connectors and a second electrical component that has first electrical connectors that are aligned in a first common plane;
teaching the third party, by an act of providing audible words or a visual depiction fixed in a tangible medium of expression to the third party, that the first electrical component and the second electrical component have a reduced insertion force, compared to mating the second electrical component with a similar first electrical component that is otherwise identical to the first electrical component but the second and third electrical connector are not offset; and
selling first, second, or third electrical connectors to the third party, a contract manufacturer of the third party, or an agent of the third party, wherein the first, second, or third electrical connectors are connected to a respective first electrical component comprising copper or a second electrical component comprising copper.
